(19) United States
(12) Patent Application Publication
(10) Pub. No.: US 2018/0003310 A1
(43) Pub. Date: Jan. 4, 2018

(54) HORIZONTAL GAS LEAK TRAP FOR A COOLANT CIRCULATION SYSTEM

(71) Applicant: FISHER JEON GAS EQUIPMENT (CHENGDU) CO., LTD., Chengdu (CN)

(72) Inventors: Li Yi, Chengdu (CN); Zhong Rufen, Chengdu (CN); Jing Na, Chengdu (CN); Yao Xiadong, Huizhou City (CN); Long Tao, Huizhou City (CN); Zhaoqing Min, Huizhou City (CN)

(73) Assignee: FISHER JEON GAS EQUIPMENT CHENGDU) CO., LTD., Chengdu (CN)

(21) Appl. No.: 15/448,440

(22) Filed: Mar. 2, 2017

(30) Foreign Application Priority Data
Jul. 1, 2016 (CN) 201610513513.1
Jul. 1, 2016 (CN) 201620692055.8

(51) Int. Cl. F16K 24/04

(52) U.S. Cl. CPC F16K 24/04

(57) ABSTRACT

A horizontal gas leak trap is provided to remove entrained gases from an industrial liquid circulation system, such as a closed water circulation system of a heat exchanger for heating natural gas in an LNG power plant. The horizontal gas leak trap includes a tank having an inlet and an outlet configured to be connected in-line to a liquid circulation system, a gas-water separator disposed inside the tank between the inlet and the outlet, a gas reservoir at the top of the tank, and a vent valve coupled to the gas reservoir and configured to vent gases out of the reservoir. The inlet and the outlet are spaced apart horizontally from each other so that liquid flowing through the tank passes across and/or through the gas-water separator.

### FIELD

This application relates generally to a horizontal gas leak trap for use in a coolant circulation system for an industrial plant.

### BACKGROUND

A typical industrial heat exchanger has a first side and a second side fluidly separated and isolated from each other by an extensive boundary. For example, a typical heat exchanger includes an enclosed vessel, such as a tank, with an inlet and an outlet and a series of tubes running through the tank such that the interior of the tubes is fluidly isolated from the interior of the tank. A first fluid, such as a gas, may run through the tubes, while a second fluid, such as a liquid coolant, simultaneously runs through the interior of the vessel. In this scenario, the surface of the tubes extending through the interior of the tank form a boundary across which heat energy from the warmer of the two fluids can pass into the cooler of the two fluids, thereby exchanging heat between the two fluid systems without actually mixing the two fluids. In this example, the interior of the tubes would be considered the gas side of the heat exchanger and the interior of the vessel surrounding the tubes would be considered the liquid side of the heat exchanger. Other typical industrial heat exchangers may use plates in addition to or alternatively to tubes to form one side of the heat exchanger or other functionally similar arrangements.

In industrial plants, such as liquid natural gas (LNG) power generation plants, heat exchangers are often used to warm the natural gas or other gases with a water circulation system in the plant. If some leakage occurs along the boundary between the two sides of the heat exchanger, for example along the pipes and/or plates within the vessel of the heat exchanger, the gas may bleed into the circulating water. Over time, if the water is part of a closed loop water circulation system, such leaked gas may accumulate within the water circulation system in an undesirable manner.

### SUMMARY

The present disclosure provides one or more systems, apparatus, and/or methods that, in some arrangements, may help prevent and/or detect undesired accumulation of leaked gas within a water or other liquid circulation system, such as from a heat exchanger in an LNG power generation plant as described above.

According to some aspects of the disclosure, a horizontal gas leak trap is configured to remove entrained gases from an industrial liquid circulation system. In some arrangements, the horizontal gas leak trap includes a tank having an inlet and an outlet configured to be connected in-line to a liquid circulation system, a gas-water separator disposed inside the tank between the inlet and the outlet, a gas reservoir at the top of the tank, and a vent valve coupled to the gas reservoir and configured to vent gases out of the reservoir. The inlet and the outlet are spaced apart horizontally from each other.

According to some aspects of the disclosure, a coolant circulation system for an industrial plant includes a horizontal gas leak trap configured to remove gases that have been entrained in the liquid coolant in a heat exchanger. In some arrangements, the coolant circulation system includes a heat exchanger, a liquid coolant circulation system operatively coupled to the heat exchanger, and a horizontal gas leak trap operatively disposed in-line with the liquid coolant circulation system downstream from the heat exchanger. The heat exchanger has a gas side and a liquid side and is configured to exchange heat between the gas side and the liquid side. The liquid coolant circulation system is configured to transport a liquid coolant through the liquid side. The horizontal gas leak trap is configured to remove gases from the liquid coolant that have been entrained in the liquid coolant at the heat exchanger.

Any one of these aspects and/or arrangements may further include any one or more of the following optional arrangements and/or features.

In some arrangements, the tank may be in the form of an elongate tubular body having an axis that is disposed horizontally. The inlet and the outlet of the horizontal gas leak trap may be disposed at opposite horizontal ends of the tank. For example, the inlet and the outlet may be disposed through end walls and/or side walls of the tank and spaced (vertically) downwardly from a top wall of the tank. The inlet and the outlet may be aligned with the horizontal axis. One or more tank supports may be provided to support the tank in the horizontal position.

In some arrangements, at least a second gas-water separator may be disposed inside the tank between the inlet and the outlet. The second gas-water separator may be spaced apart horizontally from the first said gas-water separator. More than two gas-water separators may be disposed inside the tank in order to provide multiple gas-water separation locations for liquid passing through the tank. Each of the one or more gas-water separators inside the tank may be disposed between the inlet and the outlet. One or more of the gas-water separators may be a vertically oriented panels that extends downwardly across the inside of the tank between the liquid inlet and the liquid outlet.

In some arrangements, the gas reservoir may be formed of a housing extending upwardly from an opening in the top wall of the tank. Preferably, the opening is through a top-most region of the top wall so that gases cannot become trapped in other areas of the tank. The housing may be formed of a pipe segment coupled to the top wall of the tank and surrounding the opening in the top wall of the tank. A removable cover, such as a blind flange may be coupled to the top of the pipe segment, for example, with bolts, to enclose the gas reservoir. In other arrangements, the gas reservoir may be formed by an upper most region within the tank that forms an air pocket above the liquid flowing through the tank.

In some arrangements, the vent valve may include a one-way valve configured to allow gases to escape from out of the gas reservoir and not to allow gases to reenter the gas reservoir therethrough. The vent valve may be attached to the removable cover of the gas reservoir. The vent valve may be configured to open only above a pre-selected minimum gas pressure threshold.

In some arrangements, a gas monitor may be configured to detect the presence of one or more gases within the gas reservoir. The gas monitor may be or include a handheld gas analyzer and/or an infrared gas analyzer. The gas monitor may be configured to detect the presence of natural gas. The gas monitor may be configured to send a signal to a monitoring device when a preselected concentration of a gas is detected. The gas monitor allows the gas leak trap to also serve as a monitoring device to monitor for undesirable presence and/or buildup of a gas, for example, natural gas that could be entrained into water coolant of a closed water circulation system from the heat exchanger in an LNG power plant.

In some arrangements, a liquid level meter may be configured to display and/or monitor the height of liquid within the tank. The liquid level meter may be used to detect if the level of liquid flowing through the horizontal gas leak trap rises above or falls below a preselected height level or range of height levels within the tank.

In some arrangements, an over-pressure relief valve may be coupled to the tank and configured to allow fluids to escape from the tank in an over-pressure situation. The over-pressure relief valve may be coupled to a relief opening through a top wall of the tank, such as a pipe stub or flanged opening. The relief opening may be spaced horizontally apart from the gas reservoir. The over-pressure relief valve may prevent catastrophic failures of the horizontal gas leak trap caused by an undesired pressure build up inside the tank.

In some arrangements, the industrial plant may be an LNG power plant or another type of industrial plant. The gas side of the heat exchanger may be operatively coupled to a natural gas line or another type of industrial gas. The liquid coolant may be water or oil or another liquid suitable use as a coolant inside the plant. For example, the heat exchanger may be configured to warm natural gas from the natural gas line with the water. Thus, the heat exchanger may be used to pre-heat natural gas for more efficient burning within the plant.

In some arrangements, a bypass line may be coupled to the liquid coolant circulation system in parallel with the horizontal gas leak trap and configured to selectively bypass the horizontal gas leak trap. One or more bypass valves provided to selectively control whether liquid is directed through or is bypassed around the horizontal gas leak trap.

The horizontal gas leak trap may be particularly well suited for use in LNG power plants, as described herein, to prevent undesired buildup of natural gas within a closed water circulation system, for example from the heat exchanger. Preferably, the horizontal gas leak trap is configured to respond, for example, with an alarm or automatic implementation of precautionary measures, within six seconds if gas leakage greater than or equal to 2.5 l/min occurs in the heat-exchanger. Further, in some arrangements, the effectiveness of a horizontal gas leak trap in accordance with this disclosure can be more than 95%, thereby providing high efficiency and a fast response. Further, a horizontal gas leak trap in accordance with this disclosure can provide both a low cost and easy to install solution to the problem of a possible undesirable buildup of entrained gases within a closed water or other liquid circulation system.

These and other aspects, arrangements, features, and/or technical effects will become apparent upon detailed inspection of the figures and the following description.

### BRIEF DESCRIPTION OF THE DRAWINGS

FIG. 1 is a schematic diagram of a horizontal gas leak trap of the present disclosure installed in a closed water circulation system of a heat exchanger; and

FIG. 2 is a partial cutaway side view of the horizontal gas leak trap of FIG. 1.

### DETAILED DESCRIPTION

Before describing the specific examples shown in the drawings, some general aspects, arrangements, and features of the disclosed horizontal gas leak trap and coolant circulation system are provided.

In some arrangements of the disclosure, a horizontal gas leak trap includes a horizontal tank casing. An inlet pipe of the horizontal tank may be connected with a heat-exchanger outlet pipe. An outlet pipe of the horizontal tank may be connected with the closed water circulating system of the heat-exchanger. A first gas-water separator and optionally a second gas-water separator are installed in the horizontal tank and are used to separate out gas that leaks into the water at the heat exchanger from the water. A gas reservoir is disposed on the top of horizontal tank. A manhole and a removable cover for the manhole may also be disposed on the top of the horizontal tank, preferably covering the gas reservoir. An automatic vent valve is connected with the gas reservoir and may be installed on the top of the removable cover for the manhole. A liquid level meter is installed between the horizontal tank and the gas reservoir in order to observe the liquid level in the horizontal tank.

In some arrangements the horizontal gas leak trap is operatively installed along the closed water circulation system of a heat-exchanger in an LNG power plant that wams the natural gas. One or more bypass pipes parallel the horizontal gas leak trap are provided so that the water circulation system can remain in operation while the horizontal gas leak trap is taken off-line for maintenance.

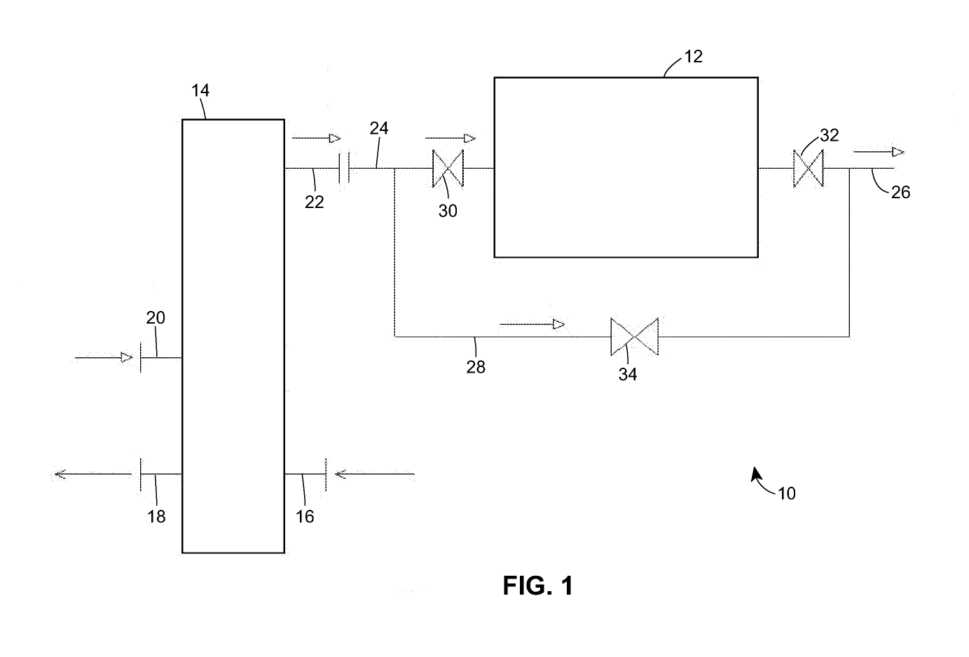

Turning now to the exemplary arrangements of the drawings, FIG. 1 shows an arrangement of a coolant circulation system 10 including a horizontal gas leak trap 12 in accordance with principles of the present disclosure. This arrangement is exemplary only, and other arrangements of a coolant circulation system in accordance with the principles disclosed herein are contemplated.

In this arrangement, the coolant circulation system 10 is a closed water circulation system of a heat exchanger 14. However, the coolant circulation system 10 may use a different liquid, such as oil or other suitable liquid, as a coolant. Furthermore, the coolant circulation system 10 does not need to be a closed circulation system. Here, the coolant circulation system 10 is part of a LNG system, such as typically found in an LNG power plant. However, the horizontal gas leak trap 12 may be installed and used in other industrial systems where capturing and/or monitoring the amount of an undesired entrained gas within a water circulation system is desired.

The heat exchanger 14 includes an vessel, such as an enclosed tank, with a gas side and a liquid side. The gas side of the heat exchanger 14 includes a gas inlet 16 into the vessel and a gas outlet 18 out of the vessel. The gas side inlet 16 is operatively coupled to a source of gas, such as natural gas. Gas from the gas inlet 16 travels through the interior of the vessel and out the gas outlet 18. The liquid side of the heat exchanger 14 includes a liquid inlet 20 into the vessel and a liquid outlet 22 out of the vessel. A continuous liquid boundary, such as pipe walls and/or plates, is formed within the vessel to separate the liquid side from the gas side in any sufficient manner understood in the art. In this arrangement, the heat exchanger 14 is used to warm the natural gas flowing into the heat exchanger at the gas inlet 16 as part of an LNG power plant. However, the heat exchanger 14 may be used in other arrangements.

The horizontal gas leak trap 12 is operatively coupled in-line in the coolant circulation system 10 to remove entrained gases from the liquid coolant. In particular, gas leak trap 12 is located in-line in the coolant circulation system 10 downstream from the heat exchanger 14 in order to remove, collect, and/or monitor gases that may become entrained in the liquid coolant at the heat exchanger 14, for example, due to leaks in the boundary between the liquid side and the gas side of the heat exchanger 14. Thus, the horizontal gas leak trap 12 is fluidly coupled to the liquid outlet 22, for example by a line 24, such as a pipe and/or hose extending from the liquid outlet 22 to the horizontal gas leak trap 12. Liquid coolant leaving the heat exchanger 14, such as water traveling through the line 24, travels into and through the horizontal gas leak trap 12, which removes entrained gases from the liquid coolant. After passing through the horizontal gas leak trap 12, the liquid coolant travels further along the coolant circulation system 10, for example through a line 26 operatively coupled to the horizontal gas leak trap 12. Thus, the horizontal gas leak trap can prevent unwanted build-up of gases within the coolant circulation system 10.

A bypass arrangement may be provided to allow liquid coolant to bypass the horizontal gas leak trap 12. In one arrangement, a bypass line 28 couples the line 24 directly to the line 26 and bypassing the gas leak trap 12. The bypass line 28 may include one or more bypass pipes connecting the line 24 with the line 26 in parallel with the horizontal gas leak trap 12. Shutoff valves 30, 32, and 34 are configured to selectively allow the liquid coolant to be directed through either or both of the horizontal gas leak trap 12 and the line 26. The shut off valve 30 is operatively disposed along the line 24 between the bypass line 28 and the horizontal gas leak trap 12 and can be opened or closed to allow or prevent liquid coolant from the liquid outlet 22 from entering into the horizontal gas leak trap 12. Shutoff valve 32 is operatively disposed along the line 26 between the bypass line 28 and the horizontal gas leak trap 12 and may be opened or closed to allow or prevent liquid coolant from the bypass line 28 from entering the horizontal gas leak trap 12. The shut off valve 34 is operatively disposed along the bypass line 28 and may be opened or closed to allow or prevent liquid coolant from bypassing the horizontal gas leak trap 12. Thus, for example, liquid coolant exiting the liquid outlet 22 of the heat exchanger 14 may be directed through the horizontal gas leak trap 12 by closing the shut off valve 34 and opening the shut off valves 30 and 32. Similarly, liquid coolant exiting the liquid outlet 22 of the heat exchanger may be bypassed around the horizontal gas leak trap 12 by closing the shut off valves 30 and 32 and opening the shut off valve 34. The bypass arrangement allows the horizontal gas leak trap 12 to be taken off-line, for example for maintenance, while the coolant circulation system 10 is still operating, without having to shut down the heat exchanger 14 and/or the coolant circulation system 10.

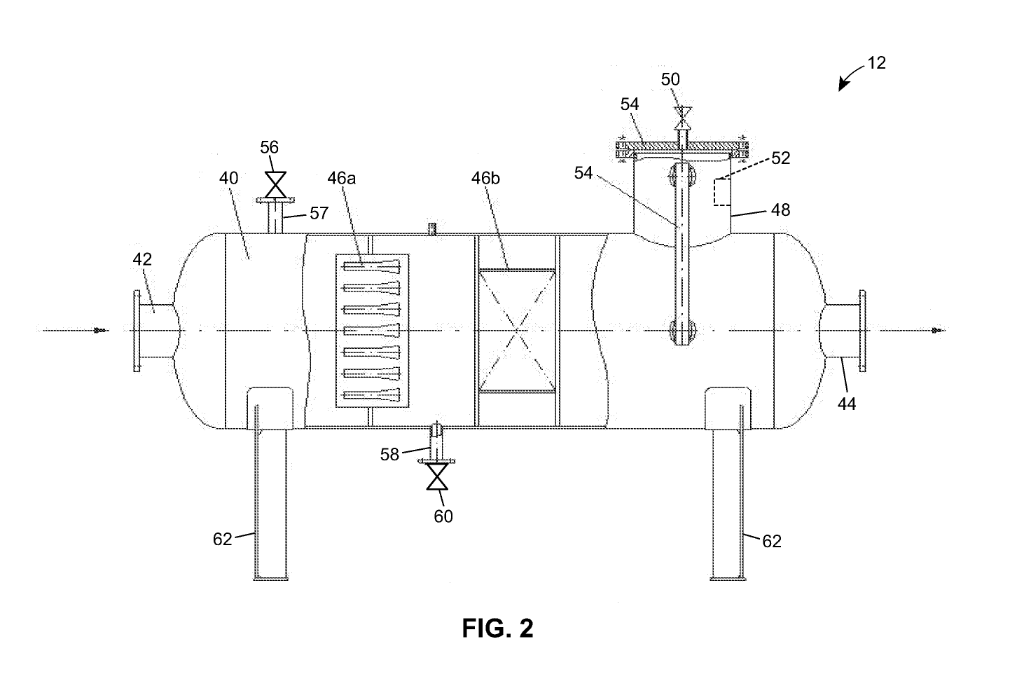

In FIG. 2, an exemplary arrangement of the horizontal gas leak trap 12 includes a tank 40 having a liquid inlet 42 and a liquid outlet 44. The liquid inlet 42 is spaced apart horizontally from the liquid outlet 44 such that liquid flowing from the liquid inlet 42 to the liquid outlet 44 travels horizontally through the interior of the tank 40 and through one or more gas-water separators 46. A gas reservoir 48 at the top of the tank 40 is configured to collect gases that have been separated out from the liquid by the gas-water separators 46. The gas reservoir is located above the horizontal level or levels of the liquid inlet 42 and the liquid outlet 44. A vent valve 50 is coupled to the gas reservoir 48 and configured to vent accumulating gases within the gas reservoir 48, for example to the outside atmosphere or to a collection system. As liquid, such as coolant water from the heat exchanger 14, flows through the tank 40 from the liquid inlet 42 to the liquid outlet 44, the liquid passes through and/or over and/or across the gas-water separators 46, which separate out entrained gases from the liquid. The separated gases rise or float vertically or otherwise upwardly to the top surface of the liquid, and migrate upwardly into the gas reservoir 48, for example through the air pocket above the horizontal liquid level, where the separated-out gases are collected. The vent valve 50 is configured to allow the gases to escape from the gas reservoir 48. In this way, the horizontal gas leak trap 12 can be configured to remove entrained gases from a liquid. In addition, a gas monitor 52 may be provided to detect the presence of one or more gases within the gas reservoir 48. Thus, when the horizontal gas leak trap 12 is operatively connected in-line within the coolant circulation system 10 as shown in FIG. 1, the horizontal gas leak trap 12 can remove natural gas from the coolant circulation system 10 that may be leaking from the heat exchanger 14. Further, when provided, the gas monitor 52 may provide data to an operator helpful for determining whether the coolant circulation system 10 needs to receive maintenance, for example to repair a leak inside the heat exchanger 14 and/or implement other precautionary measures, such as turning off or bypassing the heat exchanger 14.

Preferably, the tank 40 is arranged such that the liquid level within the tank leaves at least a small air pocket between the liquid level and the upper inside surface of the tank 40 for the accumulation of the entrained gas as described hereinafter. In the exemplary arrangement of FIG. 2, the tank 40 is formed of an elongate cylindrical tank body that extends horizontally between opposite ends, the liquid inlet 42 is defined by an inlet pipe at one end of the cylindrical tank body, and the liquid outlet 44 is defined by an outlet pipe at the opposite end of the cylindrical tank body. The liquid inlet 42 and the liquid outlet 44 are disposed at the same horizontal level with each other and along the axis of the cylindrical tank body. However, other arrangements of the tank 40 are possible, as long as the liquid traveling through the tank 40 must travel horizontally from the liquid inlet 42 to the liquid outlet 44 and through the one or more gas-water separators 46.

The one or more gas-water separators 46 are disposed inside the tank 40 between the liquid inlet 42 and the liquid outlet 44 and are arranged and configured to engage the liquid traveling from the liquid inlet 42 to the liquid outlet 44 so as to separate any entrained gases in the liquid out of the liquid. In this exemplary arrangement, two gas-water separators 46a and 46b are disposed inside the tank 40. The gas-water separators 46a and 46b are spaced apart horizontally along the length of the tank. Thus, entrained gas is separated out of the liquid twice, once by each gas-water separator 46a and 46b, as the liquid passes from the liquid inlet 42 to the liquid outlet 44. However, in other arrangements, a single gas-water separator 46 or more than two gas-water separators 46 may be disposed inside the tank 40. In addition, the first gas-water separator 46a may be either the same or different from the second gas-water separator 46b. The gas-water separators 46 may take any suitable form, as would be understood in the art. In the present example, the gas-water separators 46 are in the form of vertically oriented panels that extend downwardly between the liquid inlet 42 and the liquid outlet 44 and into the liquid flowing through the tank 40 below the air pocket between the upper surface of the liquid in the upper inside surface of the tank 40.

The gas reservoir 48 is fluidly coupled to and/or defined by an upper portion of the tank 40 in order to collect gases that have been separated out from the liquid by the gas-water separators 46. Preferably, an entrance into the gas reservoir 48 is disposed in an area of the upper surface and/or top wall of the tank 40 along where the air pocket forms above the liquid inside the tank 40. In this manner, entrained gases in the liquid that are separated out from the liquid by the gas-water separators 46 migrate upwardly into the air pocket and from the air pocket into the gas reservoir 48. In the present example, the gas reservoir 48 is in the form of a short pipe segment extending upwardly from the top side of the horizontally arranged cylindrical body of the tank 40. The gas reservoir 48 is enclosed from the outside atmosphere, for example with a cover, such as a blind flange 51 attached to the top of the short pipe segment. By being enclosed, the gas reservoir 48 collects gases that have been separated from the liquid flowing through the tank 40. The blind flange 51 may be opened to provide a manhole for access into the tank 40, for example, for inspection and/or maintenance inside the tank 40.

The vent valve 50 is disposed at the highest location of the reservoir 48 so that gas within the gas reservoir 48 will travel upwardly and out of the grass reservoir 48 through the vent valve 50. In this exemplary arrangement, the vent valve 50 is disposed on the blind flange 51 that covers the top end of the pipe segment that defines the gas reservoir 48 extending upwardly from the tank 40. However, other arrangements for the vent valve 50 suitable for venting gases accumulated within the gas reservoir 48 may also be used. Preferably, the vent valve 50 is a one-way valve configured to allow gases to escape from the gas reservoir 48 to the outside atmosphere or a collection system but not to allow gases to reenter the gas reservoir 48 from the outside atmosphere or collection system. In some arrangements, the vent valve 50 may be configured to open only after a pre-selected minimum threshold gas pressure is reached within gas reservoir 48.

Optionally, a gas monitor 52 may be configured to detect the presence of one or more gases within the gas reservoir 48. For example, the gas monitor 52 may be a handheld gas analyzer, infrared gas analyzer, and/or other types of gas monitor. In this arrangement, the gas monitor 52 is disposed on an inside wall of the gas reservoir 48. However, other configurations of the gas monitor 52 sufficient to detect the presence of one or more selected gases inside the gas reservoir 48 may be used. For example, where the horizontal gas leak trap 12 is used to remove natural gas that may be leaking from the heat exchanger 14, as explained previously, the gas monitor 52 may be configured to detect the presence of natural gas within the gas reservoir 48. When the gas monitor 52 detects natural gas above some preselected threshold value, it may indicate that the heat exchanger 14 needs to be serviced, for example by being overhauled to repair leaks between the gas side and the liquid side of the heat exchanger. In some arrangement, the gas monitor 52 may be configured to send a signal to a monitoring device, such as a plant computer, when a preselected concentration of the preselected gas is detected, which may be used to provide an alert to a user and/or automatically initiate other precautionary measures. However, in other arrangements, the gas monitor 52 may be omitted from the horizontal gas leak trap 12 and/or may be provided intermittently, for example, by a service technician during the maintenance round.

A liquid level meter 54 may also optionally be provided on the horizontal gas leak trap 12. The liquid level meter 54 is configured to display and/or monitor the height of the liquid within the tank 40. In the exemplary arrangement of FIG. 2, the upper surface of the liquid, which defines the horizontal plane, is preferably maintained at a level spaced apart from and between the upper surface of the tank 40 and the height of the inlet pipe in the outlet pipe such that the air pocket extends along the entire length of the tank 40. This way, removed gases can migrate horizontally through the air pocket along the length of the tank 40 to the gas reservoir 48. The liquid level meter 54 extends vertically from the main body of the tank 42 the gas reservoir 48 so as to show and/or measure the height of the liquid inside the tank 40. Thus, liquid level meter 54 may be used to ensure that the liquid level within the tank is somewhere spaced vertically apart from and between the top inside surface of the tank 40 and the liquid inlet 42 and liquid outlet 44 so as to ensure that an air pocket is maintained above the gas-water separators 46 to allow separated out gases to migrate to the gas reservoir 48 in the manner described previously herein. The liquid level meter 54 may include, for example, a vertical length of transparent tubing to allow an operator to visually inspect the liquid level within the tank. Additionally or alternatively, the liquid level meter 54 may provide an electronic signal to a control system, such as a plant control computer system, to provide ongoing monitoring of the liquid level within the tank 40. In this way, the liquid level monitor 54 may be used to monitor the performance of the horizontal gas leak trap 12, for example, to maintain the liquid level within the tank 40 at a preferred operational level and/or to cause an alarm when the liquid level within the tank 40 rises above and/or falls below a pre-selected level or range of levels.

An over-pressure relief valve 56 optionally may be coupled to the tank 40 and configured to allow fluids, including liquids and/or gases, to escape from the tank 40 in an over-pressure situation. In the illustrated example, the over-pressure relief valve 56 is connected to relief opening 57 through a top wall of the tank 40, which in this arrangement is formed by a connection pipe protruding vertically upwardly from the top wall of the tank 40. The connection pipe is spaced horizontally apart from the pipe segment of the gas reservoir 48. In this arrangement, if the liquid level within the tank 40 were to rise too high, the over-pressure relief valve 56 allows excess liquid to flow out of the tank 40. Similarly, the over-pressure relief valve 56 may allow an excessive build-up of gas pressure in the air pocket above the top surface of the liquid to escape when the gas pressure exceeds a selected pressure threshold. Thus, the over-pressure relief valve 56 may prevent or minimize a catastrophic failure of the horizontal ghastly trap 12, for example, if the liquid outlet 44 were to become plugged or an extremely large gas leak were to occur in the heat exchanger 14.

A drain 58 optionally may be provided to drain liquid from the tank 40. The drain 58 preferably may be selectively opened and closed, for example by a drain valve 60, so that liquid is drained through the drain 58 only when desired. In this arrangement, the drain 58 is in the form of a drain pipe extending downwardly from a bottom surface of the tank 40, and the drain valve 60 is attached to the drain pipe. However, other arrangements of the drain 58 suitable for draining liquid from the tank 40 are also possible.

One or more tank supports 62 are provided to hold the tank 40 in a preferred preselected horizontal position. In this exemplary arrangement, two tank supports 62 are provided at opposite ends of the tank 40. However, any arrangement of tank supports 62 suitable for maintaining the horizontal gas leak trap 12 in a preferred operating position and configuration may be used.

This detailed description is to be construed as examples only and does not describe every possible embodiment, as describing every possible embodiment would be impractical, if not impossible. One could implement numerous alternate embodiments, using either current technology or technology developed after the filing date of this application. Thus, while specific exemplary forms are illustrated and described herein, it is to be understood that any of the various aspects, arrangements, and/or features disclosed herein may be combined with any one or more of the other aspects, arrangements, and/or features disclosed herein in a manner that would be understood by a person of ordinary skill in view of the teachings of this disclosure.

We claim:

1. A horizontal gas leak trap comprising:
a tank having an inlet and an outlet configured to be connected in-line to a liquid circulation system, the inlet and the outlet spaced apart horizontally from each other;
a gas-water separator disposed inside the tank between the inlet and the outlet;
a gas reservoir at the top of the tank; and
a vent valve coupled to the gas reservoir and configured to vent gases out of the reservoir.

2. The horizontal gas leak trap of claim 1, wherein the inlet and the outlet are disposed at opposite horizontal ends of the tank.

3. The horizontal gas leak trap of claim 2, wherein the tank comprises an elongate tubular body having an axis disposed horizontally.

4. The horizontal gas leak trap of claim 1, further including at least a second gas-water separator disposed inside the tank between the inlet and the outlet and spaced apart horizontally from the first said gas-water separator.

5. The horizontal gas leak trap of claim 1, wherein the gas-water separator comprises a vertically oriented panel that extends downwardly between the liquid inlet and the liquid outlet.

6. The horizontal gas leak trap of claim 1, wherein the vent valve comprises a one-way valve configured to allow gases to escape from out of the gas reservoir and not to allow gases to reenter the gas reservoir therethrough.

7. The horizontal gas leak trap of claim 1, further comprising a gas monitor configured to detect the presence of one or more gases within the gas reservoir.

8. The horizontal gas leak trap of claim 7, wherein the gas monitor comprises at least one of a handheld gas analyzer and an infrared gas analyzer.

9. The horizontal gas leak trap of claim 7, wherein the gas monitor is configured to detect the presence of natural gas.

10. The horizontal gas leak trap of claim 7, wherein the gas monitor is configured to send a signal to a monitoring device when a preselected concentration of a gas is detected.

11. The horizontal gas leak trap of claim 1, further comprising a liquid level meter configured to display and/or monitor the height of liquid within the tank.

12. The horizontal gas leak trap of claim 1, further comprising an over-pressure relief valve coupled to the tank and configured to allow fluids to escape from the tank in an over-pressure situation.

13. The horizontal gas leak trap of claim 12, wherein the over-pressure relief valve is coupled to a relief opening through a top wall of the tank.

14. A coolant circulation system for an industrial plant, comprising:
a heat exchanger having a gas side and a liquid side and configured to exchange heat between the gas side and the liquid side;
a liquid coolant circulation system operatively coupled to the heat exchanger configured to transport a liquid coolant through the liquid side; and
a horizontal gas leak trap operatively disposed in-line with the liquid coolant circulation system downstream from the heat exchanger,
wherein the horizontal gas leak trap is configured to remove gases from the liquid coolant that have been entrained in the liquid coolant at the heat exchanger.

15. The coolant circulation system of claim 14, wherein the horizontal gas leak trap includes a gas reservoir configured to collect the removed gases and a vent valve configured to vent the collected gases from the gas reservoir.

16. The coolant circulation system of claim 14, wherein the horizontal gas leak trap includes a gas monitor configured to detect the presence of one or more gases within the gas reservoir.

17. The coolant circulation system of claim 14, wherein the industrial plant comprises an LNG power plant, the gas side of the heat exchanger is operatively coupled to a natural gas line, and the liquid coolant is water.

18. The coolant circulation system of claim 17, wherein the heat exchanger is configured to warm natural gas from the natural gas line with the water.

19. The coolant circulation system of claim 14, further comprising a bypass line coupled to the liquid coolant circulation system in parallel with the horizontal gas leak trap and configured to selectively bypass the horizontal gas leak trap.

20. The coolant circulation system of claim 14, wherein the horizontal gas leak trap comprises:
a tank having an inlet and an outlet spaced apart horizontally from each other, the inlet fluidly connected to an outlet from the liquid side of the head exchanger to receive liquid coolant exiting the heat exchanger, and an outlet connected to the liquid circulation system;
a gas-water separator disposed inside the tank between the inlet and the outlet;
a gas reservoir at the top of the tank; and
a vent valve coupled to the gas reservoir,
wherein the gas-water separator is configured to separate out gases from the liquid coolant exiting the heat exchanger,
wherein the gas reservoir is configured to collect the gases that are separated out from the liquid coolant, and
wherein the vent valve is configured to vent the collected gases out of the reservoir.
